(19) United States
(12) Patent Application Publication
(10) Pub. No.: US 2015/0244236 A1
(43) Pub. Date: Aug. 27, 2015

(54) ELECTROMECHANICAL STRUCTURE IMPROVEMENT DEVICE

(71) Applicant: Yung-Chen Lin, Taipei (TW)

(72) Inventor: Yung-Chen Lin, Taipei (TW)

(21) Appl. No.: 14/597,322

(22) Filed: Jan. 15, 2015

(30) Foreign Application Priority Data
Feb. 21, 2014 (CN) 201410059526.7

(51) Int. Cl. H02K 7/00; H02K 1/22; H02K 5/18; H02K 1/12

(52) U.S. Cl. CPC H02K 7/003; H02K 1/12; H02K 1/22; H02K 5/18

(57) ABSTRACT

An electromechanical structure improvement device, where a rotor taking a “U” shape is combined together through a connection, a plurality of magnetic steels are disposed on a “U”-shaped inner wall and present as an upper-and-lower corresponding relationship, the stator is disposed at a central portion of two corresponding ones of the plurality of magnetic steels, which may move in a posture cutting magnetic lines by passing double faces of a coil of the stator, whereby the efficacies of an increased power density, an enhanced electric efficiency, an increased electric dynamic energy and a promoted operational power are achieved. In addition to a single body form, at least two stators may be connected together by connecting their assemble connection portion and interconnection portion, and at least two rotors connects together, which may further connect a plurality of stator and rotor sets in series.

### FIELD OF THE INVENTION

The present invention relates to an electromechanical structure improvement device, and particularly to an electromechanical structure improvement device which may be used in its single set form or in a multi-sets-connected-in-series.

### DESCRIPTION OF THE RELATED ART

A conventional electromechanical structure improvement device is generally composed of a stator and a rotor, and the stator and rotor operate in coordination to generate an energy within an electric device. The electric energy may be further converted into a mechanical energy, and by which a dynamic energy is generated to drive a device and electric equipment associated with the electric device.

However, for an enhanced dynamic energy and power, such conventional electromechanical structure improvement device has to be provided as a plurality of sets, or its winding set has to get larger. That is, this actual use state requires more electromechanical structure improvement device, lending to demerits of poorer practicability and lack of flexible use

To solve the above demerits, the inventor of the present invention sets forth an electromechanical structure improvement device.

### SUMMARY OF THE INVENTION

It is, therefore, an object of the present invention to provide an electromechanical structure improvement device, where a rotor taking a “U” shape is combined together through a connection, a plurality of magnetic steels are disposed on a “U”-shaped inner wall and present as an upper-and-lower corresponding relationship, the stator is disposed at a central portion of two corresponding ones of the plurality of magnetic steels, which may move in a posture cutting magnetic lines by passing double faces of a coil of the stator, whereby the efficacies of an increased power density, an enhanced electric efficiency, an increased electric dynamic energy and a promoted operational power are achieved.

In addition to a single body form, at least two stators may be connected together by connecting their assemble connection portion and interconnection portion, and at least two rotors connects together, which may further connect a plurality of stator and rotor sets in series as required to achieve a better practicability, an increased electric dynamic energy, an enhanced operational power, and an increased flexible use.

To achieve the above object, the electromechanical structure improvement device according to the present invention is provided as comprising a stator and a rotor movably combined therewithin, the stator having two ends having an assemble connection portion and an interconnection portion, at least two of the stator being connected together with the assemble connection portion and the interconnection portion thereof as required, respectively, the rotor combined within the stator being connected through a core axis and a connection sleeve at a central portion together, further connecting a plurality of sets of the rotor and the stator for all the at least two of the stator.

In an embodiment, the stator comprises a stator heat-sinking outer case and an electric winding set extending on the outer case, the heat-sinking outer case and the winding case being combined as a body.

In an embodiment, wherein the rotor comprises an inner-and-outer ring body fixation unit and a plurality of magnetic steels, the inner-and-outer ring body fixation unit having a rotor outer-ring body and a rotor inner-ring body disposed thereon, the plurality of magnetic steels being disposed between the rotor inner-ring body and the rotor outer-ring body, forming a gap taking a “U” shape for accommodating an electric winding, and the plurality of magnetic steels corresponding to the gap of the stator for all the eat least two of the stator.

In an embodiment, each of the inner-ring body fixation unit has an inner rim, having a sleeve connection portion movable connected to the core axis.

In an embodiment, the rotor is connectable to a plurality of rotors through an extended connection sleeve together the core axis.

### BRIEF DESCRIPTIONS OF THE DRAWINGS

The present invention will be better understood from the following detailed descriptions of the preferred embodiments according to the present invention, taken in conjunction with the accompanying drawings, in which:

FIG. 1 is a schematic diagram of a basic architecture according to the present invention;

FIG. 2 is a schematic diagram of an exploded state according to the present invention;

FIG. 3 is a schematic diagram of an exploded state of a multiple sets connected in series according to the present invention; and

FIG. 4 is a schematic diagram of an assembled state of a multiple sets connected in series according to the present invention.

### DESCRIPTION OF THE PREFERRED EMBODIMENTS

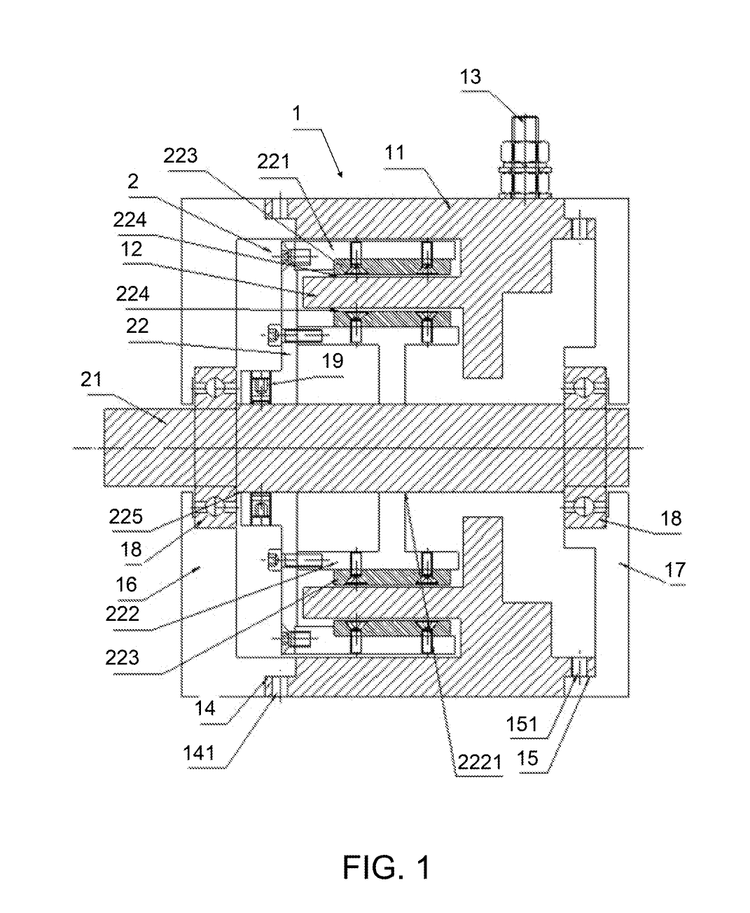

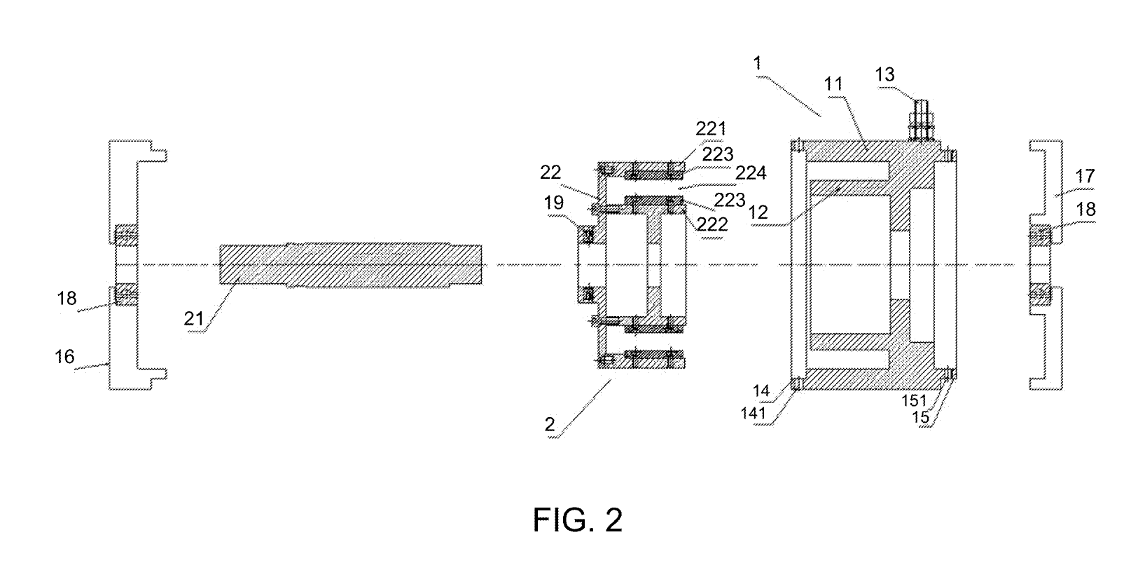

Referring to FIG. 1 and FIG. 2, a schematic diagram of a basic architecture according to the present invention, and a schematic diagram of an exploded state according to the present invention, are shown therein, respectively. As shown, the present invention is an electromechanical structure improvement device, and which comprises a stator 1 and a rotor 2.

The mentioned stator 1 comprises a stator heat-sinking outer case 11, an electric winding 12 extending within the stator heat-sinking outer case 11, and a plurality of connection line pillars 13 disposed on a surface of the stator heat-sinking outer case 11. The stator heat-sinking outer case 11 has an end having an assemble connection portion 14 disposed thereat, while an interconnection portion 15 disposed at another end.

The assemble connection portion 14 has an indented shape (or a protruding shape), while the interconnection portion 15 presents a protruding shape (or an indented shape). And, the assemble connection portion 14 and the interconnection portion 15 have an interconnection portion 141 and an interconnection threaded hole 151. In addition, there is a cover body 16, 17 disposed at two ends of the stator heat-sinking outer case 11 for enclosing the assemble portion 14 and the interconnection portion 15, respectively. In each of the cover bodies 16, 17, a bearing 18 is respectively included.

The rotor 2 is movably combined with the stator 1, and the rotor 2 comprises a core axis 21 and an inner- and outer-ring fixation unit 22. The core axis 21 is movably combined with each of the bearings 18, and the inner- and outer-ring fixation unit 22 is combined with the core axis 21 and disposed at a circumference of the electromechanical winding 12. A fixation element 19 is used along with a sleeve connection portion 225 for fixation with the core axis 21. A rotor inner-ring body 222 and a rotor outer-ring body 221 are disposed outside the inner- and outer-ring body fixation unit 22, respectively.

The rotor inner- and outer-ring body 222 and the rotor outer-ring body 221 each have an end fixed and thus combined with the inner- and outer-ring fixation unit 22. A plurality of magnetic steels 223 are disposed within the rotor outer-ring body 221 and outside the rotor inner-ring body 222 and correspond to the electromechanical winding 12. Further, between the magnetic steels 223 on the rotor inner-ring body 222 and the magnetic steel 223 on the outer-ring body 221 forms a “U” shape, and has a gap 224 for accommodating the electromechanical winding 12. The inner- and outer-magnetic steels 223 are disposed corresponding to the gap 224. And, the rotor inner-ring body 222 has an inner circumference has a sleeve connection portion 2221 connected with the core axis 21. As such, a novel electromechanical structure improvement device is completed.

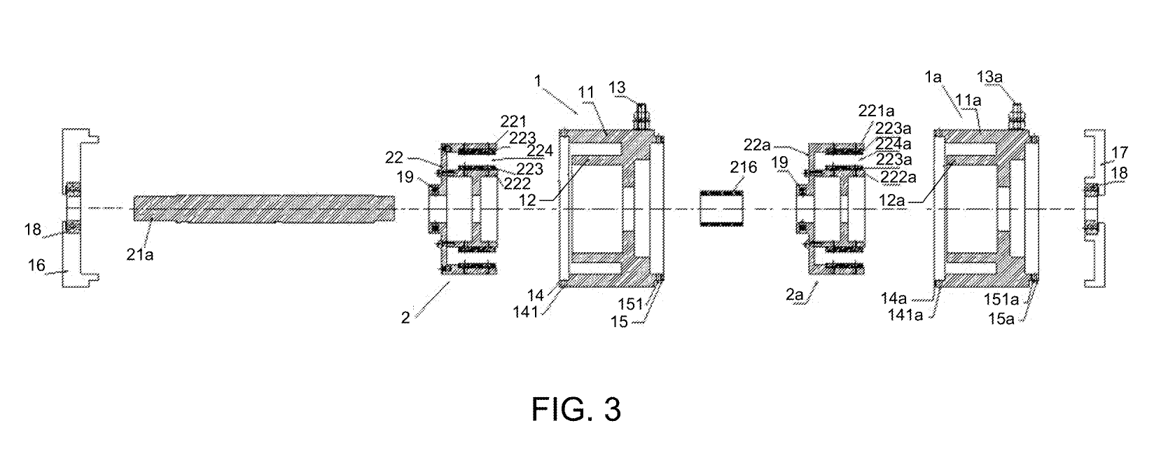

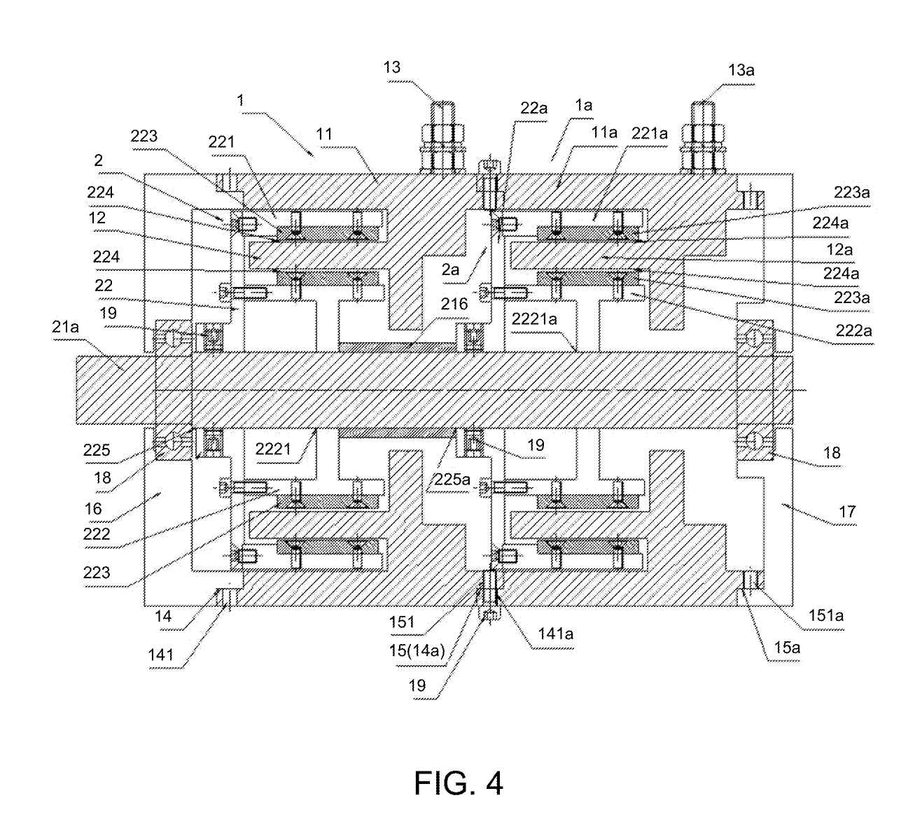

Referring to FIG. 3 and FIG. 4, a schematic diagram of an exploded state of a multiple sets connected in series according to the present invention, and a schematic diagram of an assembled state of a multiple sets connected in series according to the present invention, are shown, respectively.

As shown, when the present invention is used, in addition to the structure shown in FIG. 1 may be used in its single body form, a plurality of such structures may be used in series. Now two sets of the structure are used in series and examplified for description. Such electromechanical structure comprises two stators 1, 1a, and two rotors 2, 2a corresponding the stators 1, 1a, respectively.

When they are connected in series, the core axis 21a having an appropriate length (at least may enable itself to go through the two sets of stators 1, 1a) is provided for connection with the rotor 2 by using the fixation element 19 along with the sleeve connection portion 225. Then, the stator 1 is sleeved outside the rotor 2, with the electromechanical winding 12 disposed within the gaps 224 of the inner- and outer-ring body 221, 222 and corresponding to the magnetic steel 223. At this time, the stator 1 and the rotor 2 within the stator 1 is disposed at an end of the core axis 21a. Thereafter, another rotor 2a is fixed to the core axis 21a in the similar way to the above described for the fixation of the rotor 2, by using the fixation element 19 along with the sleeve connection portion 225a and the sleeve connection portion 216 between the rotor 2 and the rotor 2a.

Then, another stator 1a is sleeved outside the rotor 2a, and two stators 1, 1a are combined to each other by connecting their assemble portion 14 and interconnection portion 15a. And, Between the assemble connection portion 14 and the interconnection portion 15a, the fixation element 19 is used for fixation between the sleeve connection hole 141 and the sleeve connection threaded-hole 151. In this manner, the outer case 11, 11a of the two stators 1, 1a are connected in series. On the other hand, the electromechanical winding 12a of the stator 1a is similarly disposed within the rotor and within the gap 224a of the outer-ring bodies 221a, 222a, respectively and corresponds to the respective magnetic steels 223a. In this manner, the stator 1a and the rotor 2a within the stator 1a are disposed at another end of the core axis 21a. And, between two rotors 2, 2a, an extended connection sleeve 216 is disposed for blockage. Finally, a cover body 16, 17 is combined to the interconnection portion 15a and the assemble connection portion 14 of the two stators 16, 17, respectively. And, the bearing 18 within the cover body 16, 17 is sleeved onto the core axis 21a. As such, a predetermined sets of stators 1, 1a and rotors 2, 2a may be achieved through the above mentioned connection manner. In such way, a better practicability, increased electromechanical dynamic energy, enhanced operational power and effective operational flexibility may be achieved. However, the connection sequence as mentioned above is merely one of the possible implementations, without limiting the present invention. In real operation, different sequences may be possible, depending upon the use requirement.

In summary, in addition to the single body form, at least two stators may be connected together by connecting their assemble connection portion and interconnection portion, and at least two rotors connect together, which may further connect a plurality of stator and rotor sets in series as required to achieve in a better practicability, an increased electric dynamic energy, an enhanced operational power, and an increased flexible use. A rotor taking a “U” shape is combined together through a connection, a plurality of magnetic steels are disposed on a “U”-shaped inner wall and present as an upper-and-lower corresponding relationship, the stator is disposed at a central portion of two corresponding ones of the plurality of magnetic steels, which may move in a posture cutting magnetic lines by passing double faces of a coil of the stator, whereby the efficacies of an increased power density, an enhanced electric efficiency, an increased electric dynamic energy and a promoted operational power are achieved.

From all these views, the present invention may be deemed as being more effective, practical, useful for the consumer's demand, and thus may meet with the requirements for a patent.

The above described is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the claims.
stator 1,1a
stator heat sinking outer case 11,11a
electric winding 12,12a
connection line pillar 13,13a
assemble connection portion 14,14a
sleeve connection hole 141,141a
interconnection portion 15,15a
sleeve connection threaded-hole 151,151a
cover body 16,17
bearing 18
fixation element 19
rotor 2,2a
core axis 21a
inner and outer-ring body fixation unit 22,22a
rotor outer-ring body 221,221a
rotor inner-ring body 222,222a
rotor inner-ring body sleeve connection portion 2221,2221a
magnetic steel 223,223a
gap 224,224a
sleeve connection portion 225,225a
extended connection sleeve 216

What is claimed is:

1. An electromechanical structure improvement device, comprising a stator and a rotor movably combined therewithin, the stator having two ends having an assemble connection portion and an interconnection portion, at least two of the stator being connected together with the assemble connection portion and the interconnection portion thereof as required, respectively, the rotor combined within the stator being connected through a core axis and a connection sleeve at a central portion together, further connecting a plurality of sets of the rotor and the stator for all the at least two of the stator.

2. The electric structural improvement device, wherein the stator comprises a stator heat-sinking outer case and an electric winding set extending on the outer case, the heat-sinking outer case and the winding case being combined as a body.

3. The electromechanical structure improvement device as claimed in claim 2, wherein the rotor comprises an inner-and-outer ring body fixation unit and a plurality of magnetic steels, the inner-and-outer ring body fixation unit having a rotor outer-ring body and a rotor inner-ring body disposed thereon, the plurality of magnetic steels being disposed between the rotor inner-ring body and the rotor outer-ring body, forming a gap taking a “U” shape for accommodating an electric winding, and the plurality of magnetic steels corresponding to the gap of the stator for all the eat least two of the stator.

4. The electromechanical structure improvement device as claimed in claim 3, wherein each of the inner-ring body fixation unit has an inner rim, having a sleeve connection portion movable connected to the core axis.

5. The electromechanical structure improvement device as claimed in claim 3, wherein the rotor is connectable to a plurality of rotors through an extended connection sleeve together the core axis.

6. The electromechanical structure improvement device as claimed in claim 3, wherein the stator heat-sinking out case has an end having an assemble connection portion disposed thereat and another end having an interconnection portion disposed thereat.
